(19) United States
(12) Patent Application Publication
(10) Pub. No.: US 2021/0266510 A1
(43) Pub. Date: Aug. 26, 2021

(54) IMAGE PROCESSING APPARATUS, IMAGE PROCESSING METHOD, AND IMAGE PROCESSING PROGRAM

(71) Applicant: SONY CORPORATION, Tokyo (JP)

(72) Inventor: Teijiro HAYASHI, Saitama (JP)

(73) Assignee: SONY CORPORATION, Tokyo (JP)

(21) Appl. No.: 17/260,402

(22) PCT Filed: Aug. 6, 2019
(86) PCT No.: PCT/JP2019/031010

§ 371 Date: Jan. 14, 2021

(30) Foreign Application Priority Data
Aug. 17, 2018 (JP) 2018-153666

(51) Int. Cl. H04N 13/111; G02B 27/00; H04N 13/161; H04N 5/232

(52) U.S. Cl. CPC H04N 13/111; G02B 27/0093; G02B 2027/0123; H04N 5/23238; H04N 5/23296; H04N 13/161

(57) ABSTRACT

An image processing apparatus (100) according to an embodiment includes: a reception unit (131) that receives a change from a first angle-of-view to a second angle-of-view for a partial image included in a designated area of a wide angle-of-view image displayed on a display unit (12); and an image generation unit (132) that performs, in a case where the change in the angle-of-view has been received by the reception unit, maintaining a display of at least one of a plurality of first images each having a first resolution different from the resolution of the wide angle-of-view image and having been decoded before the change to the second angle-of-view, and performs decoding of a second image that is an image displayed on the display unit after the change to the second angle-of-view and having a second resolution different from the resolution of the first image while maintaining the display of the at least one first image on the display unit.

### FIELD

The present disclosure relates to an image processing apparatus, an image processing method, and an image processing program. More specifically, the present disclosure relates to image processing performed at zooming a wide angle-of-view image.

### BACKGROUND

With the spread of virtual reality (VR) technology, spherical cameras capable of omnidirectional imaging in 360 degrees are widely used. Moreover, devices such as a head-mounted display (HMD) have begun to spread as a viewing environment for spherical content such as spherical images and spherical movies captured by a spherical camera.

Here, various techniques have been proposed for performing playback of images having an angle-of-view wider than the angle-of-view displayed on the display, such as spherical content and panoramic images (hereinafter, collectively referred to as “wide angle-of-view images”). For example, there is a known technique for reducing the impact of delay in playback due to buffering by presenting information of a specific part existing on the playback side to the user until the playback data of the specific part is ready when receiving an instruction to switch the specific part to be played (for example, Patent Literature 1). Furthermore, there is a technique of maintaining high response, when displaying an image having identical content, by first displaying low-resolution data and then displaying high-resolution data in response to a request from the user (for example, Patent Literature 2). Furthermore, a technique of scrolling on a wide angle-of-view image in the horizontal direction and the vertical direction at a low component cost is known (for example, Patent Literature 3).

### CITATION LIST

### Patent Literature

Patent Literature 1: JP 2003-304525 A

Patent Literature 2: JP 2005-223765 A

Patent Literature 3: JP 11-196369 A

### SUMMARY

### Technical Problem

However, the above-described techniques are not considered to be effective for improving the user experience regarding wide angle-of-view images. For example, when switching or zooming is performed, in the prior art, for the position displayed on the display of a wide angle-of-view image, switching of screen display is performed such that low-resolution data is displayed first and then high-resolution data is displayed (or vice versa).

This might cause the user to repeatedly experience switching from a vague image of low-resolution data to a clear image of high-resolution data. This problem can be severe especially when wearing an HMD, because of symptoms such as VR sickness or video sickness.

In view of this problem, the present disclosure proposes an image processing apparatus, an image processing method, and an image processing program capable of improving the user experience regarding wide angle-of-view images.

### Solution to Problem

For solving the problem described above, an image processing apparatus according to one aspect of the present disclosure has a reception unit that receives a change from a first angle-of-view to a second angle-of-view for a partial image included in a designated area of a wide angle-of-view image displayed on a display unit, and an image generation unit that performs, in a case where the change in the angle-of-view has been received by the reception unit, maintaining a display of at least one of a plurality of first images each having a first resolution different from the resolution of the wide angle-of-view image and having been decoded before the change to the second angle-of-view, and performs decoding of a second image that is an image displayed on the display unit after the change to the second angle-of-view and having a second resolution different from the resolution of the first image while maintaining the display of the at least one first image on the display unit.

### Advantageous Effects of Invention

According to the image processing apparatus, the image processing method, and the image processing program of the present disclosure, it is possible to improve the user experience regarding wide angle-of-view images. It should be noted that the effects described herein are not necessarily limited and may be any of the effects described in the present disclosure.

### BRIEF DESCRIPTION OF DRAWINGS

FIG. 1 is a diagram illustrating an example of an image processing system according to a first embodiment of the present disclosure.

FIG. 2 is a view illustrating a change in zoom magnification in a wide angle-of-view image.

FIG. 3 is a view illustrating a division layer method according to the first embodiment of the present disclosure.

FIG. 4 is a diagram illustrating an example of an image generation process according to the first embodiment of the present disclosure.

FIG. 5 is a view illustrating the relationship between a wide angle-of-view image and a user's viewpoint.

FIG. 6 is a diagram illustrating an example of an image generation process by the division layer method.

FIG. 7 is a diagram (1) illustrating an example of the image generation process according to the first embodiment of the present disclosure.

FIG. 8 is a diagram (2) illustrating an example of the image generation process according to the first embodiment of the present disclosure.

FIG. 9 is a diagram (3) illustrating an example of the image generation process according to the first embodiment of the present disclosure.

FIG. 10 is a flowchart (1) illustrating a process flow according to the first embodiment of the present disclosure.

FIG. 11 is a flowchart (2) illustrating a process flow according to the first embodiment of the present disclosure.

FIG. 12 is a hardware configuration diagram illustrating an example of a computer that actualizes functions of an image processing apparatus.

### DESCRIPTION OF EMBODIMENTS

Embodiments of the present disclosure will be described below in detail with reference to the drawings. In each of the following embodiments, the same parts are denoted by the same reference symbols, and a repetitive description thereof will be omitted.

### 1. First Embodiment

[1-1. Image Processing for Wide Angle-of-View Images]

Prior to the image processing according to the present disclosure, a method of displaying a wide angle-of-view image, which is a premise of the image processing of the present disclosure, will be described.

The wide angle-of-view image according to the present disclosure is an image such as spherical content and panoramic images, having a wider angle-of-view than the angle-of-view displayed on a display. In the present disclosure, spherical content will be described as an example of a wide angle-of-view image.

Spherical content is generated by imaging using a spherical camera capable of imaging 360 degrees in all directions. Since spherical content has a wider angle-of-view than a general display (for example, a Head Mounted Display (HMD) worn by the user), a partial area cut out in the size of the display (in other words, angle-of-view in the user's view field) is selectively displayed in playback. For example, the user views the spherical content while changing the display position by operating a touch display to change display positions or changing the line of sight or posture through the HMD worn by the user.

Since only a partial area of the spherical content is actually displayed on the display in this manner, it would be possible to suppress the processing load or improve channel bandwidth efficiency by decreasing a decoding process and data transmission for the non-displayed area.

In practice, however, there is a case, due to problems such as decoding performance of a playback device and the response delay in data distribution of a movie, where sudden switching of the viewing direction by the user causes loss of image data because the area to be displayed after the switching fails to be displayed in time. The loss of image data might lead to blank display or significant degradation of playback quality.

To avoid this, in the display process of the wide angle-of-view image, the state of retaining the minimum data for all directions is maintained in preparation for a sudden turn-around movement of the user, or the like. In this case, omnidirectional data has a large amount of information, making it difficult to hold data having a relatively high resolution (hereinafter referred to as “high resolution”). Accordingly, the spherical content is held in relatively low resolution (hereinafter referred to as “low resolution”) data. When the user views the image in practice, high-resolution data corresponding to the area to be displayed is decoded to generate a high-resolution image, and the generated high-resolution image will be superimposed on the low-resolution image and displayed.

With this method, even when the high-resolution image has not been decoded in time due to the user's sudden turn-around movement, at least the low-resolution spherical content is displayed, leading to prevention of a state where the display has no image to display. Therefore, this method enables the user to smoothly view the spherical content, leading to improvement of usability.

In such a method, it is also possible to decode a higher resolution image of the spherical content corresponding to the angle-of-view actually used in the display. For example, when a user views spherical content with a high-magnification zoom, the image quality sometimes seems to be degraded even at a normal high resolution (hereinafter, referred to as “first resolution”). Therefore, in such a method, by decoding image data having higher resolution (hereinafter referred to as “second resolution”), it is possible to provide an image of the quality that cannot be impaired by high-magnification zoom (in other words, a very narrow angle-of-view display).

In this manner, such a method switches displaying images of three types of resolutions: a low-resolution spherical content; a first resolution image (hereinafter referred to as a “first image”) corresponding to cases where the zoom magnification is 1× (non-magnification) to a relatively low magnification (when angle-of-view is relatively wide); and a second resolution image (hereinafter referred to as a “second image”) corresponding to cases where the zoom magnification is relatively high (when the angle-of-view is relatively narrow). In the present disclosure, such a method is referred to as a division layer method. For example, in the division layer method, low-resolution spherical content is ready in a decoded state, while a first resolution image or a second resolution image is decoded for individual areas. The maximum number of images that can be decoded simultaneously depends on hardware performance, for example. This method makes it possible to provide an experience of viewing a high-resolution image in a VR image viewed using an HMD, even when the user uses high zoom magnification.

However, when the user changes the zoom magnification in the division layer method, switching from the first resolution to the second resolution occurs. At this time, it is difficult, depending on the performance of the hardware, to simultaneously decode a first resolution image and a second resolution image, and thus, a low-resolution spherical content would be displayed until the switching is completed. In this case, the user has to sequentially view the images in order of the first resolution image displayed before the magnification change, the low-resolution spherical content, and the second resolution image displayed after the magnification change. This might cause the user to repeatedly experience switching from a vague image of low-resolution data to a clear image of high-resolution data. This problem can be severe especially when wearing an HMD, because of symptoms such as VR sickness or video sickness.

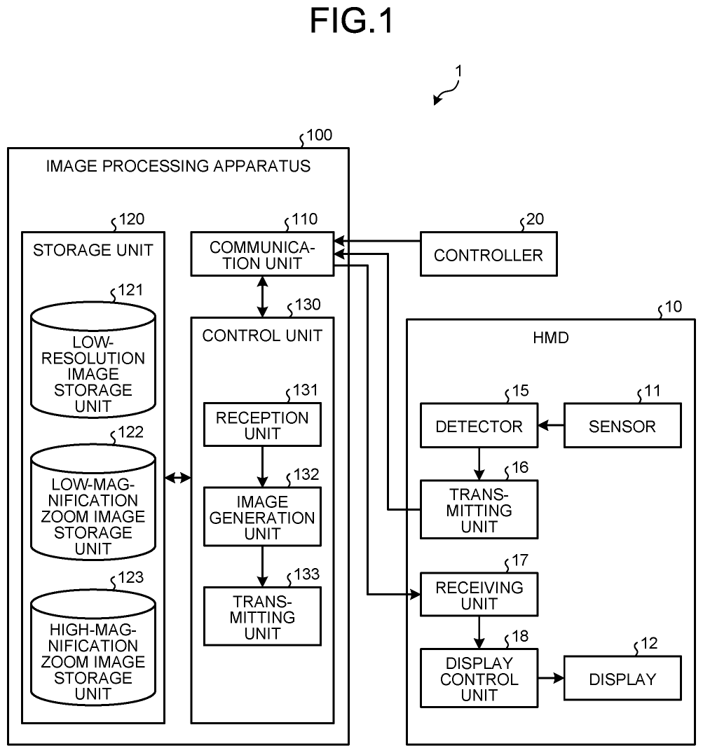

In view of this situation, even when the zoom magnification of the image displayed on the HMD or the like is changed (that is, when the angle-of-view is changed), the image processing according to the present disclosure reduces the user sickness by suppressing a sudden change in the resolution. According to the image processing of the present disclosure, it is possible to improve the user experience regarding a wide angle-of-view image. Hereinafter, each of devices included in an image processing system 1 that implements image processing according to the present disclosure will be described with reference to FIG. 1.

### 1-2. Configuration of Image Processing System According to First Embodiment

FIG. 1 is a diagram illustrating an example of an image processing system 1 according to a first embodiment of the present disclosure. As illustrated in FIG. 1, the image processing system 1 includes an HMD 10, a controller 20, and an image processing apparatus 100.

The HMD 10 is a display device mounted on the user's head and is also referred to as a wearable computer. The HMD 10 realizes display processing according to the orientation and movement of the user's body, moving speed, or the like.

The controller 20 is an information device connected to the image processing apparatus 100 and the HMD 10 via a wired or wireless network. The controller 20 is an information device held and operated by a user wearing the HMD 10, for example, and is an example of an input device for inputting information to the HMD 10 and the image processing apparatus 100. For example, the controller 20 detects the user's hand movement and the information input from the user to the controller 20, and transmits the detected information to the HMD 10 and the image processing apparatus 100. In the first embodiment, the controller 20 is used to designate an area of the spherical content to be displayed on the HMD and to designate the zoom magnification of the image displayed on the HMD. For example, the controller 20 can be any remote controller, a game controller, or the like, having a communication function (for example, bluetooth (registered trademark)) with the image processing apparatus 100 or the HMD 10.

The image processing apparatus 100 is an information processing device that executes image processing according to the present disclosure. The image processing apparatus 100 transmits the content held in the apparatus to the HMD 10 in response to a request transmitted from the HMD 10, for example.

First, configuration of the HMD 10 will be described. As illustrated in FIG. 1, the HMD 10 includes processing units such as a detector 15, a transmitting unit 16, a receiving unit 17, and a display control unit 18. Each of the processing units is implemented by execution of programs stored in the HMD 10 by a central processing unit (CPU), a micro processing unit (MPU), or the like, using random access memory (RAM) or the like, as a working area. In addition, each of the processing units may be implemented by an integrated circuit such as an application specific integrated circuit (ASIC) or a field programmable gate array (FPGA).

The detector 15 detects the operation information of the user wearing the HMD 10, which is also referred to as head tracking information. Specifically, the detector 15 controls a sensor 11 included in the HMD 10 to detect various types of information regarding the motion of a user, such as the body orientation, inclination, movement, and moving speed of the user. More specifically, the detector 15 detects information regarding the user's head and posture, movement of the user's head and body (acceleration and angular velocity), the direction of the visual field, the speed of viewpoint movement, or the like, as the information regarding the motion of the user. For example, the detector 15 controls various motion sensors as the sensor 11, such as a triaxial acceleration sensor, a gyro sensor, and a speed sensor, so as to detect information regarding the motion of the user. Note that the sensor 11 need not be provided inside the HMD 10 and may be an external sensor connected to the HMD 10 with wired or wireless connection, for example.

Furthermore, the detector 15 detects a viewpoint position at which the user is gazing on the display 12 of the HMD 10. The detector 15 may detect the viewpoint position by using various known methods. For example, the detector 15 may detect the user's viewpoint position by estimating the direction of the user's head using the above-described three-axis acceleration sensor, gyro sensor, or the like. Furthermore, the detector 15 may be used, as the sensor 11, to detect the user's viewpoint position by using a camera that captures the user's eyes. For example, the sensor 11 is installed at a position where the user's eyeballs are located within an imaging range when the user wears the HMD 10 on the head (for example, a position close to the display 12 and enabling the lens to face the user). The sensor 11 recognizes the direction in which the line of sight of the right eye is oriented, based on the captured image of the eyeball of the user's right eye and a positional relationship with the right eye. Similarly, the sensor 11 recognizes the direction in which the line of sight of the left eye is oriented, based on the captured image of the eyeball of the user's left eye and a positional relationship with the left eye. The detector 15 may detect which position of the display 12 the user is gazing at, based on such an eyeball position.

Furthermore, the detector 15 detects information related to the area (position in the spherical content) displayed on the display 12 in the spherical content. That is, the detector 15 detects information indicating an area among the spherical content designated by the user's head and posture information, or an area designated by the user by touch operation or the like. Furthermore, the detector 15 detects the setting of the angle-of-view of a partial image (hereinafter, referred to as “partial image”) of the spherical content displayed in the area. The angle-of-view setting is, in other words, the setting of the zoom magnification.

For example, the detector 15 detects the zoom magnification designated by the user in the partial image and detects the angle-of-view of the partial image to be displayed in the area. Subsequently, the detector 15 transmits the detected information to the transmitting unit 16.

The transmitting unit 16 transmits various types of information via a wired or wireless network or the like. For example, the transmitting unit 16 transmits head tracking information detected by the detector 15 to the image processing apparatus 100. Furthermore, the transmitting unit 16 transmits to the image processing apparatus 100 a request to transmit spherical content to the HMD 10. In addition, the transmitting unit 16 transmits, to the image processing apparatus 100, a display status such as which position of the spherical content is displayed by the user while the spherical content is being displayed. The transmitting unit 16 also transmits the current zoom magnification of the partial image and a change in the zoom magnification to the image processing apparatus 100.

The receiving unit 17 receives various types of information via a wired or wireless network. For example, the receiving unit 17 receives an image displayed by the display control unit 18 (more specifically, data such as pixel information to form an image displayed on the display 12).

The display control unit 18 controls the display process of the image received by the receiving unit 17. Specifically, the display control unit 18 performs a display control process of the low-resolution spherical content and the first image superimposed on the spherical content in the display area of the display 12. Furthermore, the display control unit 18 performs the display control process of the second image superimposed on the spherical content in the display area of the display 12 in a case where high zoom magnification is set on the display 12.

The display 12 is a display unit that displays an image on the HMD 10, and is actualized by an organic Electro-Luminescence (EL) display, a liquid crystal display, or the like.

Although not illustrated in FIG. 1, the HMD 10 may include an input unit for receiving an operation from a user, a storage unit that stores images such as received spherical content, and an output unit having a voice output function.

Next, configuration of the image processing apparatus 100 will be described. As illustrated in FIG. 1, the image processing apparatus 100 includes a communication unit 110, a storage unit 120, and a control unit 130.

The communication unit 110 is actualized by Network Interface Card (NIC), for example. The communication unit 110 is connected to a network (Internet, or the like) by wired or wireless connection, and transmits/receives information to/from the HMD 10, the controller 20, or the like, via the network.

The storage unit 120 is implemented by semiconductor memory elements such as Random Access Memory (RAM) and flash memory, or other storage devices such as a hard disk or an optical disk. The storage unit 120 includes a low-resolution image storage unit 121, a low-magnification zoom image storage unit 122, and a high-magnification zoom image storage unit 123.

The low-resolution image storage unit 121 stores information related to the low-resolution image (for example, image data that is the source of the image displayed on the display unit of the HMD 10) among the content to be transmitted to the HMD 10. The low-resolution image is specifically an image that covers the omnidirectional positions of the wide angle-of-view image displayed on the HMD 10. A low-resolution image has omnidirectional coverage but has low resolution instead, making it possible prevent occurrence of heavy processing load or burden on the band used in the communication with HMD10 during decoding and transmission to HMD10. As an example, a low-resolution image has a resolution (1920×1080 pixels (equirectangular)) corresponding to Full High Definition (Full HD).

The low-magnification zoom image storage unit 122 stores a first image, which is a high-resolution image for low-magnification zoom (for example, from the state of no zoom to less than 3×), among the content to be transmitted to the HMD 10. For example, when assuming that the angle-of-view with no zoom is “100°”, the first image is an image that covers a range from “100°” to “35°” being 3× zoom angle-of-view, or more. Specifically, in a case where the zoom magnification satisfies the above conditions and when a wide angle-of-view image is displayed on the HMD 10, the first image will be displayed so as to be superimposed on the low-resolution image.

When the low-resolution image has a resolution corresponding to full HD, the first image has a resolution corresponding to 8 k or 18 k, for example. For example, when the first image has a resolution of 8 k, the first image corresponding to one piece of spherical content is an image divided by a vertical angle-of-view of 90° and a horizontal angle-of-view of 90°, each of the images having resolution “2048×2048 pixels”. Furthermore, when the first image has a resolution of 18 k, for example, the first image corresponding to one piece of spherical content is an image divided by a vertical angle-of-view of 30° and a horizontal angle-of-view of 45°, each of the images having resolution “2304×1280 pixels”. In this manner, high-resolution images are appropriately divided and held so as to substantially equally divide the amount of information.

The high-magnification zoom image storage unit 123 stores the second image, which is a high-resolution image for high-magnification zoom (for example, 3× or more), among the content transmitted to the HMD 10. For example, when assuming that the angle-of-view with no zoom is “100°”, the second image is an image that covers a range below “35°” being 3× zoom angle-of-view. Specifically, in a case where the zoom magnification satisfies the above conditions and when a wide angle-of-view image is displayed on the HMD 10, the second image will be displayed so as to be superimposed on the low-resolution image.

When the low-resolution image has a resolution corresponding to full HD, the second image has a resolution corresponding to 44 k, for example. For example, when the second image has a resolution of 44 k, the second image corresponding to one piece of spherical content is an image divided by a vertical angle-of-view of 22° and a horizontal angle-of-view of 13.7°, each of the images having resolution “1664×2560 pixels”. With the division in this manner, the amount of information in the second image has substantially the same amount of information as the first image.

The control unit 130 is implemented by execution of programs stored in the image processing apparatus 100 (for example, an image processing program according to the present disclosure) by the CPU, MPU, or the like, using RAM or the like as a working area. Furthermore, the control unit 130 may be a controller and may be actualized by using an integrated circuit such as an ASIC or an FPGA, for example.

As illustrated in FIG. 1, the control unit 130 includes a reception unit 131, an image generation unit 132, and a transmitting unit 133, and actualizes or executes information processing functions or operations described below. The internal configuration of the control unit 130 is not limited to the configuration illustrated in FIG. 1, and may be another configuration as long as it is a configuration that performs information processing described below.

The reception unit 131 acquires various types of information via a wired or wireless network or the like. For example, the reception unit 131 acquires head tracking information or the like transmitted from the HMD 10. Furthermore, the reception unit 131 receives a request transmitted from the HMD 10 and containing a request to transmit the spherical content to the HMD 10.

Furthermore, the reception unit 131 receives a change from the first angle-of-view to the second angle-of-view for the partial image included in the designated area of the wide angle-of-view image. For example, the reception unit 131 receives the area designation information by the user of the HMD 10. The designation information is information that designates a certain position in the wide angle-of-view image, such as a position designated via the controller 20 or a position specified based on head tracking information. That is, the reception unit 131 receives a change in zoom magnification for the area designated based on the head tracking information or the like (area of the spherical content that is actually displayed on the display 12) out of the spherical content displayed on the HMD 10. At this time, the reception unit 131 may receive a change from the first angle-of-view to the second angle-of-view via a signal received from the input device (controller 20) used by the user.

For example, the reception unit 131 receives a change from the first angle-of-view to the second angle-of-view, which is narrower than the first angle-of-view. In other words, the reception unit 131 receives a request for zoom-in on the partial image displayed on the HMD 10.

In addition, the reception unit 131 receives a change from the first angle-of-view to the second angle-of-view, which is wider than the first angle-of-view. In other words, the reception unit 131 receives a request for zoom-out on the partial image displayed on the HMD 10.

In addition, the reception unit 131 receives information related to the user's viewpoint toward the area. In other words, the reception unit 131 receives information indicating at which part the user is gazing in the partial image displayed on the HMD 10.

The image generation unit 132 generates an image to be transmitted to the HMD 10. More specifically, the image generation unit 132 generates source data of the image displayed on the display 12 of the HMD 10.

The image generation unit 132 generates an image displayed by the HMD 10 based on the zoom magnification, head tracking information, or the like received by the reception unit 131. That is, the image generation unit 132 functions as: an acquisition unit that acquires various types of information received by the reception unit 131; a decoder that decodes the image on which an instruction is given by the acquisition unit; and a renderer that determines a display area based on the decoded image, zoom magnification, head tracking information, or the like and performs rendering (image generation) on the determined display area.

Specifically, in the image processing according to the present disclosure, in a case where the reception unit 131 has received the change from the first angle-of-view to the second angle-of-view, the image generation unit 132 maintains the display on the display unit (display 12) for at least one first image out of a plurality of the first images that has been decoded before the change to the second angle-of-view. Subsequently, the image generation unit 132 decodes the second image that is displayed on the display unit after the change to the second angle-of-view and having a second resolution different from the resolution of the first image while maintaining the display on the display unit for at least one first image.

When the decoding of the second image is completed, the image generation unit 132 replaces the first image display of which on the display unit has been maintained, with the second image decoding of which has been completed, so as to update the partial image.

Furthermore, after replacing the first image display of which on the display unit has been maintained, with the second image decoding of which has been completed, the image generation unit 132 decodes another second image having the second resolution.

Specifically, in a case where the image generation unit 132 has received a change from the first angle-of-view to the second angle-of-view, which is a narrower angle-of-view (that is, zoom-in), the image generation unit 132 decodes the second image having the second resolution being the resolution higher than the first resolution while maintaining the display of at least one of the plurality of first images to the display unit.

Furthermore, in a case where the image generation unit 132 has received a change from the first angle-of-view to the second angle-of-view, which is a wider angle-of-view (that is, zoom-out), the image generation unit 132 decodes the second image having the second resolution being the resolution lower than the first resolution while maintaining the display of at least one of the plurality of first images to the display unit.

In this case, the image generation unit 132 may determine which of the first images is to be maintained out of the plurality of first images displayed before the change to the second angle-of-view, based on the information related to the user's viewpoint, for example.

Specifically, the image generation unit 132 may maintain, with higher priority, the first image located closer to the user's viewpoint among the plurality of first images displayed before the change to the second angle-of-view.

The transmitting unit 133 transmits the image (data constituting the image) generated by the image generation unit 132 to the HMD 10.

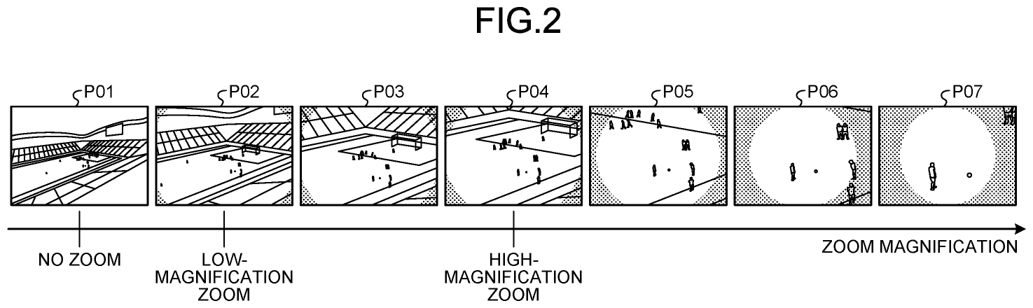

Image processing according to the present disclosure described above will be described in detail with reference to FIGS. 2 to 9. FIG. 2 is a view illustrating a change in zoom magnification in a wide angle-of-view image.

Images P01 to P07 illustrated in FIG. 2 are images that a user wearing the HMD 10 views on the display 12. For example, an image P01 is a partial image corresponding to an area that can be displayed on the display 12 of the HMD10 in the spherical content transmitted to the HMD10.

By performing a predetermined operation on the controller 20 or the HMD 10, the user changes the zoom magnification of the image that the user is viewing. This means that the reception unit 131 receives a change from the first angle-of-view to the second angle-of-view for the image viewed by the user. Note that FIG. 2 illustrates an example of zoom-in operation, in which the second angle-of-view is assumed to be narrower than the first angle-of-view.

In a case where the change from the first angle-of-view to the second angle-of-view has been received, the image generation unit 132 performs a process of updating the image P01 to an image P02 or updating the image P02 to an image P03. In the example of FIG. 2, zoom video with higher magnification are provided to the user in order from the image P01 toward the image P07. In the example of FIG. 2, it is assumed that the image P01 is a “no zoom (zoom magnification is 1×)” image, the image P02 and the image P03 are “low-magnification zoom” images, and images P04 to P07 are “high-magnification zoom” images.

That is, as described above, the image processing apparatus 100 according to the present disclosure receives a change in the angle-of-view of the partial image displayed in a certain area, and performs a process of updating the image in accordance with the change, at a predetermined timing (for example, 30 times or 60 times per second).

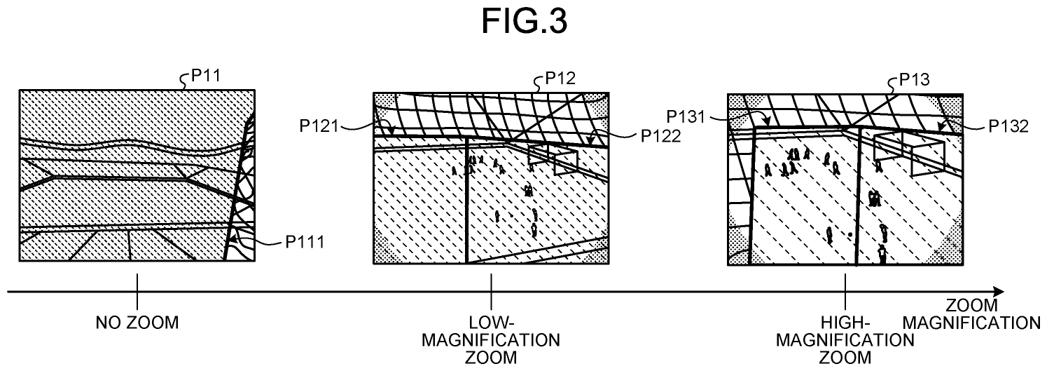

Next, with reference to FIG. 3, superimposition of high-resolution images using the division layer method will be described. FIG. 3 is a view illustrating a division layer method according to the first embodiment of the present disclosure. The example of FIG. 3 illustrates three types of images of the same position in the spherical content, the individual images having different zoom magnifications. Specifically, FIG. 3 illustrates an image P11 without zoom, an image P12 with low-magnification zoom, and an image P13 with high-magnification zoom.

For example, the image P11, together with an image P111 having a higher resolution (equivalent to 8 k in the example of FIG. 3) compared to the spherical content superimposed to the low-resolution image of the spherical content, will be displayed on the display 12. When the number of images to be decoded is “3”, it is assumed that the image generation unit 132 decodes another high-resolution image (not illustrated) in addition to the image P11 and the image P111. In this case, the other high-resolution image covers the outside of the area of the image P11. With this configuration, the image generation unit 132 can provide the user with a high-resolution image without performing new decoding even when the user moves his/her line of sight.

Subsequently, it is assumed that the user changes the zoom magnification and the image P12 is displayed on the display 12. In this case, the image generation unit 132 superimposes an image having a higher resolution (corresponding to 18 k in the example of FIG. 3). Since the higher the resolution, the narrower the area that can be covered in the image P12, the image generation unit 132 uses two decodable images other than the image P12 to perform superimposition on the image P12. In this manner, the high-resolution image is divided into a plurality of images so as to be superimposed on the low-resolution image P12. Hereinafter, a high-resolution image that is divided and superimposed may be referred to as a divided image.

That is, the image P12 is displayed on the display 12 after having divided images P121 and P122 having higher resolution superimposed on the low-resolution image of the spherical content.

Furthermore, it is assumed that the user changes the zoom magnification and the image P13 is displayed on the display 12. In this case, the image generation unit 132 superimposes an image having a higher resolution (corresponding to 44 k in the example of FIG. 3).

Specifically, the image P13 is displayed on the display 12 after having divided images P131 and P132 having higher resolution superimposed on the low-resolution image of the spherical content. In this manner, the image processing apparatus 100 displays, with superimposition, a high-resolution divided image corresponding to the zoom magnification, thereby providing the user with an image having an image quality that cannot be impaired by zooming.

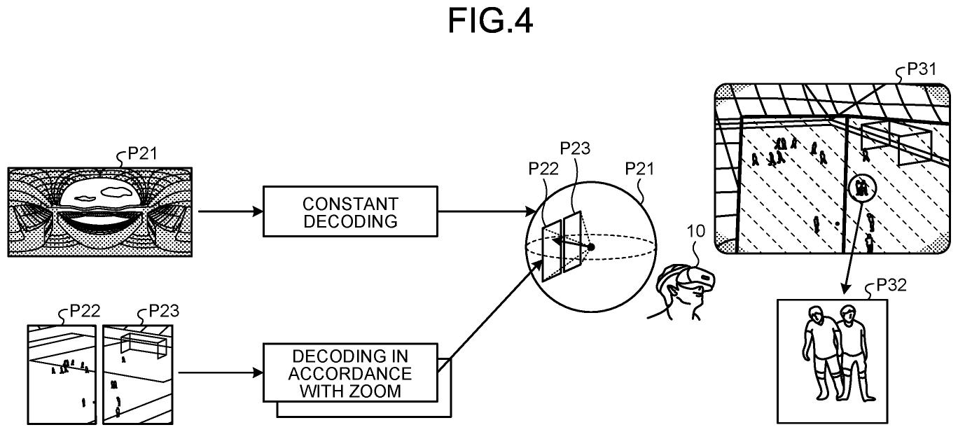

Subsequently, a process flow of the above-described division layer method will be described with reference to FIG. 4. FIG. 4 is a diagram illustrating an example of an image generation process according to the first embodiment of the present disclosure.

In the example of FIG. 4, the image processing apparatus 100 is assumed to have a performance of simultaneously decoding three images. In this case, the image generation unit 132 constantly decodes low-resolution spherical content P21. This is to prevent a blank display that would occur when the user suddenly turns around as described above.

Furthermore, the image generation unit 132 decodes high-resolution images, which are divided image P22 and divided image P23, in accordance with the current zoom magnification.

Based on the head tracking information in the HMD 10, the image generation unit 132 specifies the position of the spherical content P21 that the user is viewing and superimposes the divided images P22 and P23 on that position. With this operation, the display 12 of the HMD 10 displays an image P31 obtained by superimposing the divided images P22 and P23 on the position of the user's viewpoint in the spherical content. Since the high-resolution divided images P22 and P23 are superimposed on the image P31, the user can view a clear image as illustrated in an image P32, for example.

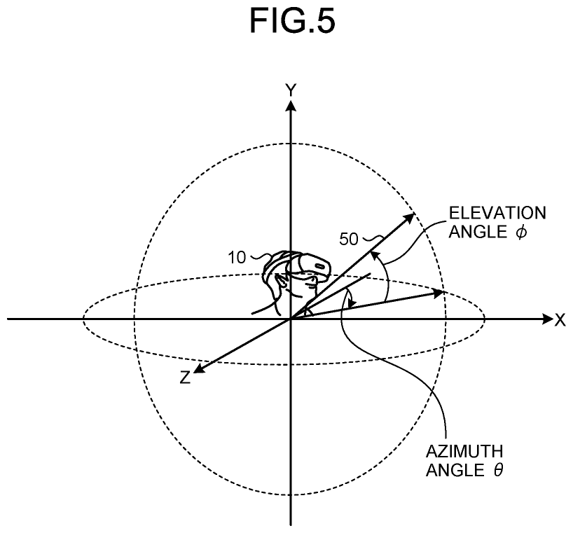

Here, a relationship between a wide angle-of-view image and user's viewpoint will be described with reference to FIG. 5. FIG. 5 is a view illustrating a relationship between a wide angle-of-view image and user's viewpoint. In the example of FIG. 5, a spherical content will be described as an example of a wide angle-of-view image.

As illustrated in FIG. 5, the user's viewpoint in the spherical content is illustrated using an azimuth angle θ and an elevation angle ϕ. The azimuth angle θ is an angle from a predetermined reference axis on an X-Z plane, which is a horizontal plane in a 3D model coordinate system illustrated in FIG. 5. The elevation angle ϕ is an angle in an up-down direction when the X-Z plane in the 3D model coordinate system illustrated in FIG. 5 is defined as a reference plane.

For example, the image processing apparatus 100 specifies the azimuth angle θ and the elevation angle ϕ of the position where the viewpoint of the user is directed, in the 3D model coordinate system, based on the head tracking information or the like detected by the HMD 10. Next, the image processing apparatus 100 specifies a viewpoint vector 50 indicating the user's viewpoint based on the azimuth angle θ and the elevation angle ϕ. Subsequently, the image processing apparatus 100 specifies the position at which the viewpoint vector 50 intersects the 3D model coordinate system corresponding to the spherical content, as a position where the user is viewing in the spherical content.

The process of specifying the user's viewpoint as described above is an example, and the image processing apparatus 100 may specify the user's viewpoint based on various known techniques. With such processing, the image processing apparatus 100 can specify the position at which the user is viewing in the spherical content and a portion of the partial image displayed on the display 12 to which the user's viewpoint is directed.

With this configuration, for example, the image generation unit 132 can perform adjustment of displaying, with high priority, a high-resolution divided image for a part of the partial movie where the user's viewpoint is directed, and omitting display of high-resolution divided images for the part where the user's viewpoint is not directed (peripheral vision). For example, in the example of FIG. 4, the image generation unit 132 can perform adjustment of arranging two divided images in peripheral portions of the part (the part illustrated in the image P32) at which the user is gazing, and not arranging divided images in the peripheral vision (portion indicated by grid pattern in the image P31).

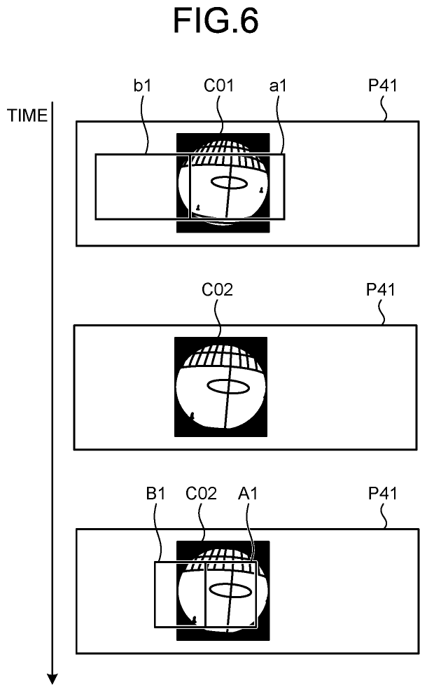

Subsequently, an image processing flow performed with the division layer method will be described in detail with reference to FIG. 6. FIG. 6 is a diagram illustrating an example of an image generation process by the division layer method. For FIGS. 6 to 9, description will be given using a schematic image displayed on one side of the display 12 (display corresponding to the user's right eye or left eye) included in the HMD 10. Furthermore, in FIGS. 6 to 9, the number of images that can be decoded by the image processing apparatus 100 is assumed to be “3”.

In the example of FIG. 6, the HMD10 acquires spherical content P41, and displays, among the content, a low-resolution image C01 corresponding to the position at which the user's viewpoint is directed, together with a divided image a1 and a divided image b1 to be superimposed on the low-resolution image C01.

Here is an assumable case where the user changes the zoom magnification. The HMD10 displays a low-resolution image C02 corresponding to the new zoom magnification. In this case, a process of decoding a divided image A1 and a divided image B1 corresponding to the new zoom magnification is performed, and thus, the divided image a1 and the divided image b1 will be erased. This is because the image processing apparatus 100 determines that “3” is the number of decodable images, among which one image has been used for decoding the spherical content P41, disabling simultaneous decoding of four images, namely, the divided image a1, the divided image b1, the divided image A1, and the divided images B1.

After having completed the decoding of the divided image A1 and the divided image B1, the image processing apparatus 100 generates an image in which the divided image A1 and the divided image B1 are superimposed on the low-resolution image C02.

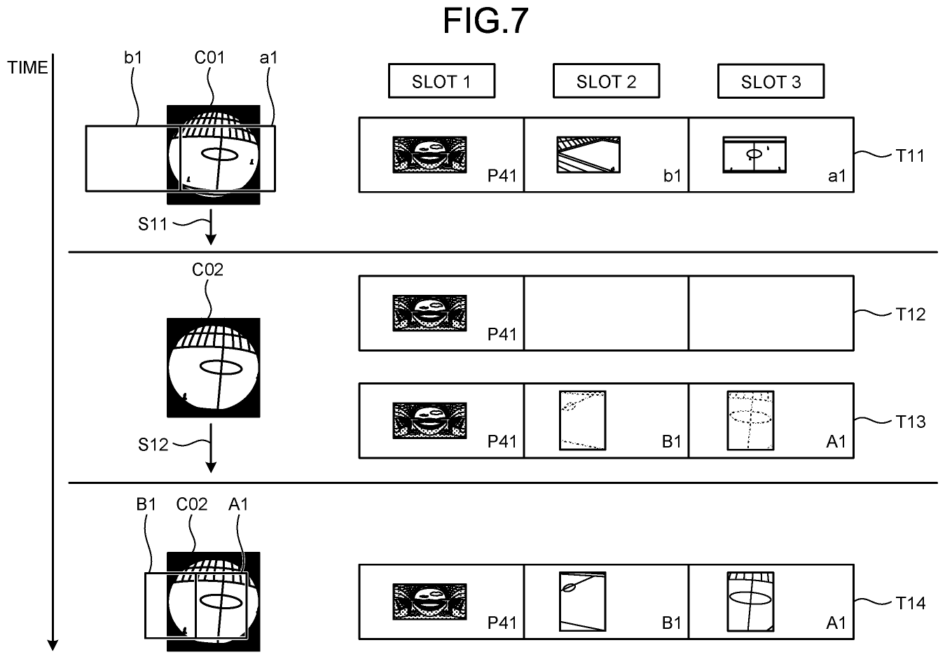

The image processing illustrated in FIG. 6 will be described with reference to FIG. 7 by visually illustrating a relationship with the processing area (hereinafter, referred to as “slot”) used by the image processing apparatus 100 to decode the image. FIG. 7 is a diagram (1) illustrating an example of the image generation process according to the first embodiment of the present disclosure.

FIG. 7 illustrates, in chronological order, an image displayed on the display 12 and the status of the slot in which the image generation unit 132 related to the image processing apparatus 100 decodes the image.

Similarly to FIG. 6, the display 12 displays the low-resolution image C01, the divided image a1, and the divided image b1. At this time, the image generation unit 132 decodes, in slot 1, the spherical content P41 including the low-resolution image C01. Furthermore, the image generation unit 132 decodes the divided image b1 in slot 2 and decodes the divided image a1 in slot 3 (timing T11).

Thereafter, having received the change of the zoom magnification (Step S11), the image generation unit 132 displays the changed low-resolution image C02. As described above, since the image generation unit 132 decodes entire positions of the spherical content P41, the low-resolution image C02 can be displayed without waiting time.

On the other hand, in a case where the image generation unit 132 has received a zoom magnification change, the decoding of the divided image a1 and the divided image b1 will be temporarily stopped because the decoding of the new divided image is required (timing T12). Subsequently, the image generation unit 132 starts decoding the new divided image A1 and the divided image B1 (timing T13). In the examples of FIGS. 7 to 9, a divided image (illustrated in non-solid line) such as timing T13 indicates that decoding is in progress.

After completion of decoding of the divided image A1 and the divided image B1, the image generation unit 132 generates an image after the zoom magnification change (Step S12).

At this time, the low-resolution image C02, the divided image A1, and the divided image B1 are displayed on the display 12. That is, the image generation unit 132 decodes the divided image B1 in slot 2, and decodes the divided image A1 in slot 3, while decoding the spherical content P41 in slot 1 (timing T14).

As described above, the examples illustrated in FIGS. 6 and 7 include occurrence of the timing at which none of the divided images is displayed. Therefore, the user would view the switching between the low-resolution image and the high-resolution image. This leads to the possibility that the above process would not be able to reduce the user's symptoms such as VR sickness.

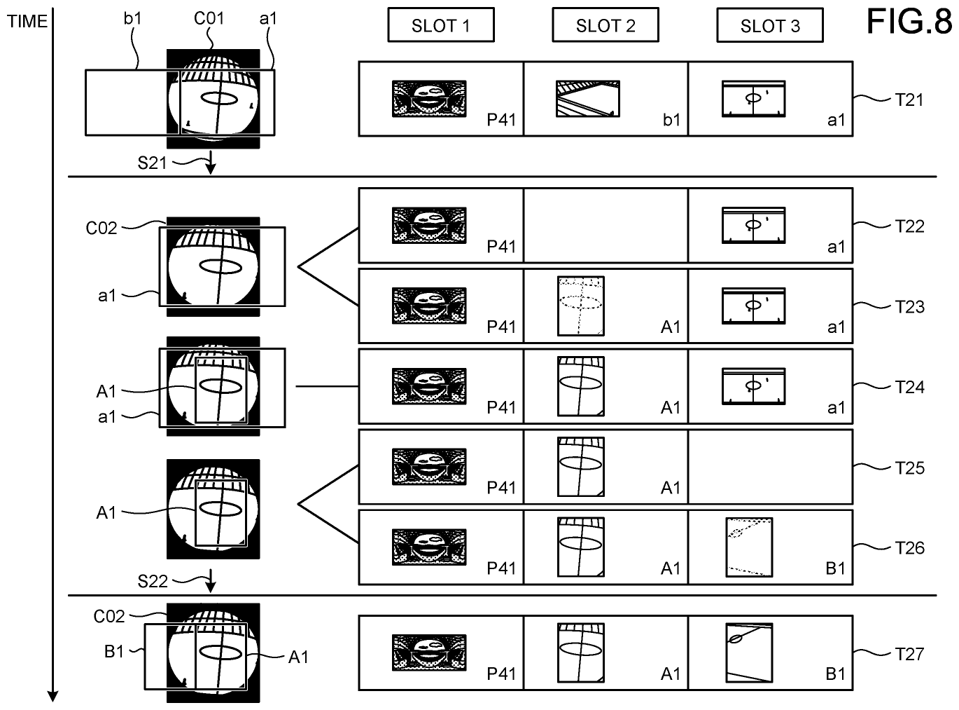

To handle this, the image processing according to the present disclosure executes the process described in FIG. 8. FIG. 8 is a diagram (2) illustrating an example of the image generation process according to the first embodiment of the present disclosure.

Similarly to FIG. 7, the display 12 displays the low-resolution image C01, the divided image a1, and the divided image b1. That is, the image generation unit 132 decodes the spherical content P41 in slot 1, decodes the divided image b1 in slot 2, and decodes the divided image a1 in slot 3 (timing T21).

Thereafter, when the change in the zoom magnification is received (Step S21), the image generation unit 132 maintains the display of at least one divided image out of the divided images decoded before the zoom magnification change. For example, regarding the slots 2 and 3, the image generation unit 132 erases the divided image b1 alone from the slot 2, and leaves the divided image a1 in the slot 3. For example, the image generation unit 132 maintains the image on the side closer to the user's viewpoint (divided image a1 in the example of FIG. 8) and erases the image on the side farther from the user's viewpoint (divided image b1 in the example of FIG. 8), among the plurality of divided images (timing T22). In this case, although the display state of the divided image a1 is maintained, the angle-of-view of the divided image a1 might be changed together with the zoom magnification change.

At timing T21, the image generation unit 132 generates an image to be displayed on the display 12 based on the low-resolution image C02, and on the divided image a1 for which display is maintained. In this case, since the divided image a1 which is a high-resolution image is maintained, the user can continue viewing the high-resolution image.

In slot 2 vacated by the erasure of the divided image b1, the image generation unit 132 starts decoding the divided image A1 after the zoom magnification change (timing T23). After completion of the decoding of the divided image A1 (timing T24), the image generation unit 132 superimposes the divided image A1 on the low-resolution image C02 and the divided image a1, so as to display the divided image A1. For example, since the divided image A1 is an image having a higher resolution than the divided image a1, the size of the image is smaller than that of the divided image a1. That is, the divided image A1 is included in the position displayed by the divided image a1. Furthermore, the divided image A1 is, for example, a peripheral area at a position closest to the user's viewpoint position.

After the divided image A1 is superimposed on the low-resolution image C02, the image generation unit 132 erases the divided image a1 maintained in slot 3 (timing T25). Subsequently, the image generation unit 132 starts decoding the divided image B1 in vacant slot 3 (timing T26).

After completion of the decoding of the divided image B1, the image generation unit 132 generates an image in which the divided image A1 and the divided image B1 are superimposed on the low-resolution image C02 (Step S22). At this time, the image generation unit 132 decodes the spherical content P41 in slot 1, decodes the divided image A1 in slot 2, and decodes the divided image B1 in slot 3 (timing T27).

As described above, in a case where the zoom magnification has been changed, the image generation unit 132 decodes the divided image obtained after the zoom magnification change while maintaining the divided image present before the zoom magnification change, unlike the processes illustrated in FIGS. 6 and 7. With this configuration, the image generation unit 132 can change the zoom magnification while maintaining a high resolution near the position at which the user is gazing. This can eliminate the need for the user to view the switching from the low-resolution vague image to the high-resolution clear image at the gaze position, making it possible to alleviate the symptoms such as VR sickness.

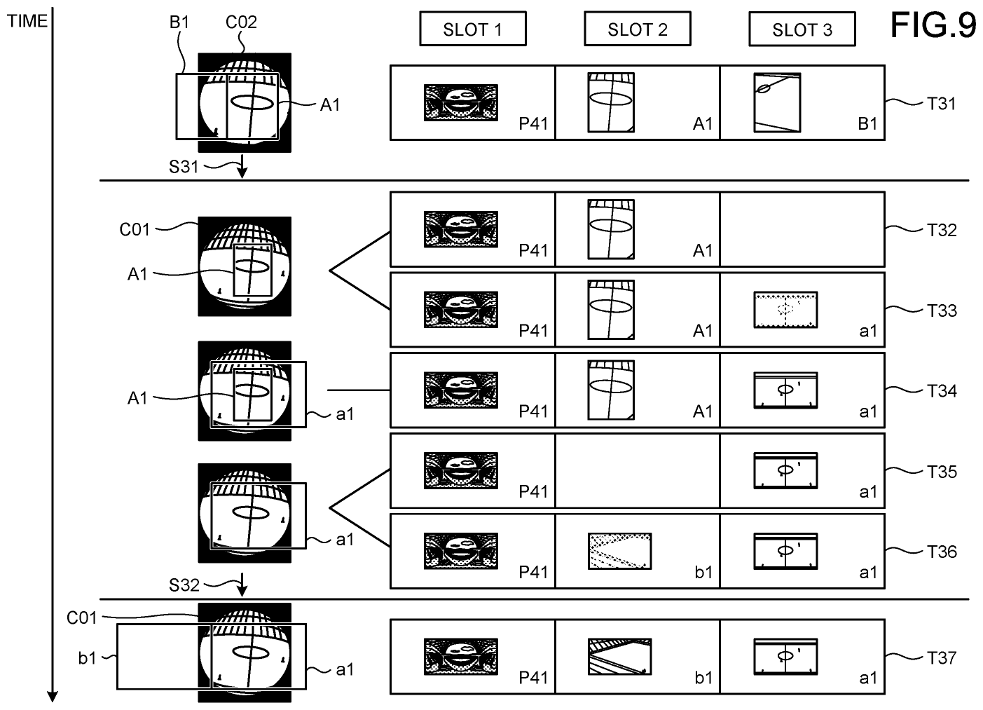

Although FIG. 8 illustrates an example of image processing in the zoom-in situation, the image generation unit 132 performs similar processing in zoom-out situations. This point will be described with reference to FIG. 9. FIG. 9 is a diagram (3) illustrating an example of the image generation process according to the first embodiment of the present disclosure.

In FIG. 9, first, a low-resolution image C02, a divided image A1, and a divided image B1 after zoom-in are displayed on the display 12. At this time, the image generation unit 132 decodes the spherical content P41 in slot 1, decodes the divided image A1 in slot 2, and decodes the divided image B1 in slot 3 (timing T31).

Thereafter, when the zoom magnification change (zoom-out) is received (Step S31), the image generation unit 132 maintains the display of at least one divided image out of the divided images decoded before the zoom magnification change. For example, regarding slots 2 and 3, the image generation unit 132 erases the divided image B1 alone from slot 3, and leaves the divided image A1 in slot 2. For example, the image generation unit 132 maintains the image on the side closer to the user's viewpoint (divided image A1 in the example of FIG. 9) and erases the image on the side farther from the user's viewpoint (divided image B1 in the example of FIG. 9), among the plurality of divided images (timing T32). In this case, although the display state of the divided image A1 is maintained, the angle-of-view of the divided image A1 might be changed together with the zoom magnification change.

At timing T32, the image generation unit 132 generates an image to be displayed on the display 12 based on the low-resolution image C01 after zoom-out and the divided image A1 for which display is maintained. In this case, since the divided image A1 which is a high-resolution image is maintained, the user can continue viewing the high-resolution image.

In slot 3 vacated by the erasure of the divided image B1, the image generation unit 132 starts decoding the divided image a1 after the zoom magnification change (timing T33). After completion of the decoding of the divided image a1 (timing T34), the image generation unit 132 superimposes the divided image a1 on the low-resolution image C01 and the divided image A1, so as to display the divided image a1. For example, since the divided image a1 is an image having lower resolution than the divided image A1, the size of the image is greater than that of the divided image A1. That is, the divided image a1 is displayed in a wider area including the position where the divided image A1 is displayed. Furthermore, the divided image a1 is, for example, a peripheral area at a position closest to the user's viewpoint position.

After the divided image a1 is superimposed on the low-resolution image C01, the image generation unit 132 erases the divided image A1 maintained in slot 2 (timing T35). Subsequently, the image generation unit 132 starts decoding the divided image b1 in the vacant slot 2 (timing T36).

After completion of the decoding of the divided image b1, the image generation unit 132 generates an image in which the divided image a1 and the divided image b1 are superimposed on the low-resolution image C01 (Step S32). At this time, the image generation unit 132 decodes the spherical content P41 in slot 1, decodes the divided image b1 in slot 2, and decodes the divided image a1 in slot 3 (timing T37).

As described above, the image generation unit 132 can change the zoom magnification while maintaining a high-resolution image near the user's viewpoint even in the case of zoom-out, as in the case of zoom-in.

### 1-3. Procedure of Image Processing According to First Embodiment

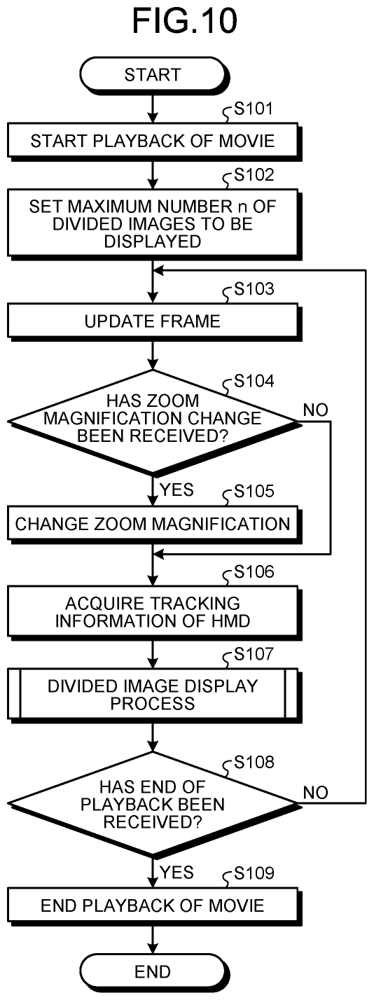

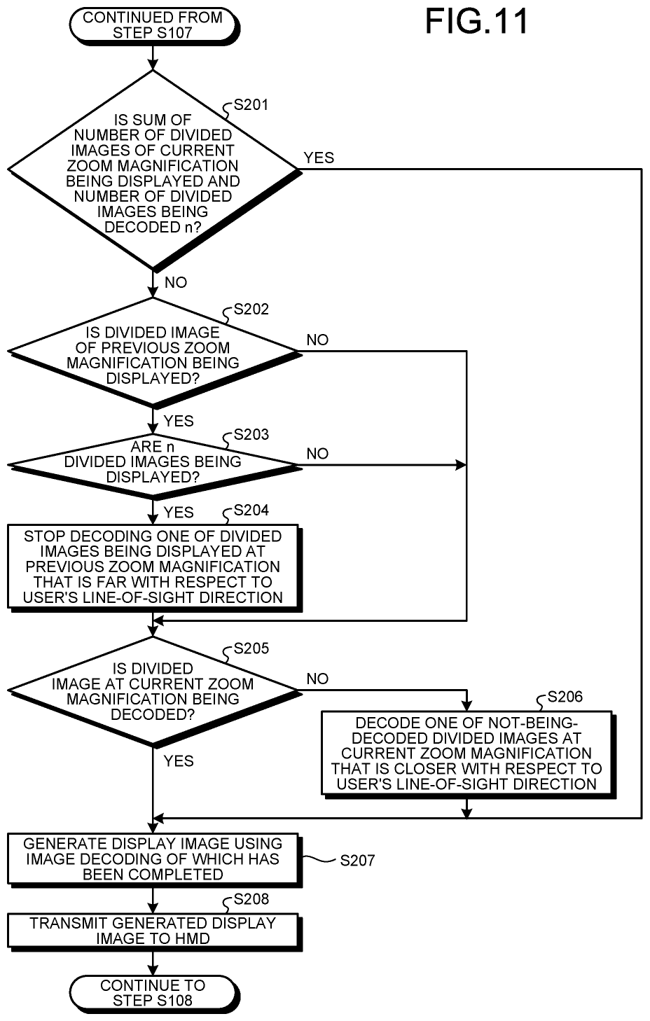

Next, an image processing procedure according to the first embodiment will be described with reference to FIGS. 10 and 11. FIG. 10 is a flowchart (1) illustrating a process flow according to the first embodiment of the present disclosure.

As illustrated in FIG. 10, the image processing apparatus 100 starts playback of the movie displayed on the display 12 following a predetermined operation received from the HMD 10 and the controller 20 (Step S101).

Here, the image processing apparatus 100 sets the maximum number “n” of divided images to be displayed, based on the hardware performance of the image processing apparatus 100 and the HMD 10 (Step S102). The number “n” is any natural number. For example, when the number of slots is “3” as illustrated in FIG. 7 or the like, the maximum number “n” of divided images to be displayed will be “2” obtained by subtracting the number corresponding to the spherical content from 3.

The image processing apparatus 100 appropriately updates the frame to be displayed, in accordance with playback of the operation (Step S103). For example, the image processing apparatus 100 updates the frame (in other words, an image displayed on the display 12) at a timing such as 30 times or 60 times per second.

Here, the image processing apparatus 100 determines whether a zoom magnification change has been received from the user (Step S104). In a case where the zoom magnification change has been received (Step S104; Yes), the image processing apparatus 100 changes the magnification to the received zoom magnification (Step S105). In a case where the zoom magnification change has not been received (Step S104; No), the image processing apparatus 100 maintains the current zoom magnification.

Furthermore, the image processing apparatus 100 acquires tracking information of the HMD 10 (Step S106). This enables the image processing apparatus 100 to determine the position of the image to be displayed (position displayed on the display 12 of the spherical content) at the next timing.

Subsequently, the image processing apparatus 100 performs a divided image display process (Step S107). The details of the divided image display process will be described below with reference to FIG. 11.

After completion of the divided image display process, the image processing apparatus 100 determines whether an end of playback of the operation has been received from the user (Step S108). In a case where the end of playback has not been received (Step S108; No), the image processing apparatus 100 continues the process of updating the subsequent frame (Step S103).

In contrast, in a case where the end of playback has been received (Step S108; Yes), the image processing apparatus 100 ends the playback of the movie (Step S109).

Subsequently, a divided image display process procedure will be described with reference to FIG. 11. FIG. 11 is a flowchart (2) illustrating a process flow according to the first embodiment of the present disclosure.

As illustrated in FIG. 11, the image processing apparatus 100 determines whether the sum of the number of divided images of the current zoom magnification (in a case where zoom magnification change has been received from the user, the zoom magnification after the change) and the number of divided images being decoded is n (Step S201).

In a case where the sum of the images is not n (Step S201; No), the image processing apparatus 100 determines whether the divided image of the previous zoom magnification (zoom magnification before the change) is being displayed (Step S202).

In a case where the divided image of the previous zoom magnification is being displayed (Step S202; Yes), the image processing apparatus 100 further determines whether n divided images are being displayed (Step S203).

In a case where n divided images are being displayed (Step S203; Yes), the image processing apparatus 100 stops decoding one of the divided images being displayed at the previous zoom magnification, which is far with respect to the user's line-of-sight direction (Step S204). That is, the image processing apparatus 100 stops decoding one divided image being displayed in order to make a space for the slot.

In cases where the divided image of the previous zoom magnification is not being displayed (Step S202; No), where n divided images are not being displayed (Step S203; No), or following Step S204, the image processing apparatus 100 determines whether the divided image at the current zoom magnification is being decoded (Step S205).

In a case where the divided image at the current zoom magnification is not being decoded (Step S205; No), the image processing apparatus 100 decodes one of the divided images at the current zoom magnification that is closer with respect to the user's line-of-sight direction (Step S206).

In cases where the divided image of the current zoom magnification is being decoded (Step S205; Yes), the process of Step S206 has been performed, or the sum of the number of divided images of the current zoom magnification and the number of divided image being decoded is n (Step S201; Yes), the image processing apparatus 100 generates a display image using the image decoding of which has been completed (Step S207). Subsequently, the image processing apparatus 100 transmits the generated display image to the HMD 10 (Step S208).

### 1-4. Modification of First Embodiment

The first embodiment described above is an example in which the image processing apparatus 100 generates an image using divided images having high-resolution such as the first resolution or the second resolution. These are merely an example, and the image processing apparatus 100 may set the resolution more finely (for example, in four or five levels).

Furthermore, described above are an example in which the image processing apparatus 100 uses two-level settings of zoom magnification such as low magnification and high magnification. However, the zoom magnification may set more finely (for example, in three or four levels).

Furthermore, the above-described image processing is an example in which the maximum number of decoding is “3”. For example, in the examples of FIGS. 7 to 9, the number of images that can be decoded by the image processing apparatus 100 is “3” (in other words, the number of slots is “3”). However, the number of slots in the image processing according to the present disclosure is not limited to “3”. That is, image processing according to the present disclosure can be applied to any case as long as the number of slots is two or more and the number of slots is less than the number enabling parallel decoding of all the divided images included in a wide angle-of-view image.

Furthermore, the first embodiment describes an example in which the image processing apparatus 100 decodes, with higher priority, the divided image displayed at the position closest to the user's viewpoint. Here, the image processing apparatus 100 may determine the decoding order of the divided images by using elements other than the user's viewpoint.

For example, the image processing apparatus 100 may decode, with higher priority, the divided image located at the center of the image displayed on the display 12. Furthermore, in a case where there is a position designated by the user in advance, the image processing apparatus 100 may decode, with higher priority, the divided image corresponding to the designated position.

Furthermore, the first embodiment has described an example in which the image processing according to the present disclosure is performed in a case where the user requests a zoom magnification change, that is, where the user requests a change in the angle-of-view of the image being displayed. However, the image processing apparatus 100 may perform the image processing according to the present disclosure even in cases other than the case where the zoom magnification change is required.

For example, in a case where the image displayed on the display 12 is a streaming movie, it is possible to encounter a situation in which the transmission state during playback of the movie changes and the image quality needs to be changed. Even with such a change in image quality, the image processing apparatus 100 can prevent, with the use of image processing of the present disclosure, occurrence of the display of low-resolution images and high-resolution images frequently alternated.

The first embodiment has described an example in which the image processing apparatus 100 performs processing defining zooming below 3× as low-magnification zoom and zooming of 3× or more as high magnification. This is merely an example, and the image processing apparatus 100 may perform the image processing according to the present disclosure based on an arbitrarily set magnification (angle-of-view).

### 2. Second Embodiment

Next, a second embodiment will be described. The first embodiment has described an example in which the image processing apparatus 100 (device that performs relatively sophisticated processing) and the HMD 10 perform processing in cooperation. However, the image processing according to the present disclosure may be performed by the HMD 10 alone, when it is equipped with a display. In this case, the image processing apparatus according to the present disclosure is represented by the HMD 10.

In this case, an image processing system 2 according to the second embodiment includes the controller 20 and the HMD 10. Furthermore, the HMD 10 includes processing units configured to individually execute the processes equivalent to those executed by the control unit 130 according to the image processing apparatus 100 illustrated in FIG. 1. In other words, the HMD 10 includes individual processing units for executing a program that actualizes the image processing according to the present disclosure.

The HMD10 does not have to include the storage unit 120. In this case, the HMD10 acquires various types of content from a predetermined storage server that holds the spherical content and high-resolution images corresponding to the spherical content, via the network.

As described above, in the second embodiment, the HMD 10 is an information device having a display 12 for displaying various types of content and configured to execute a process of generating an image to be displayed on the display 12. For example, the HMD 10 may be a smartphone VR goggle that is realized by inserting a smartphone or the like into a goggle-shaped housing.

In this manner, the HMD 10 according to the second embodiment functions as an image processing apparatus that executes the image processing according to the present disclosure. That is, the HMD 10 can execute the image processing according to the present disclosure as a standalone device, without depending on the image processing apparatus 100 or the like. Furthermore, the HMD 10 according to the second embodiment makes it possible to implement, as standalone operation, the processes including the display control process such as displaying the image generated by the image processing according to the present disclosure, on the display 12. With this configuration, the HMD 10 according to the second embodiment can implement the image processing according to the present disclosure with a simple system configuration.

While the above has described an exemplary case of using the HMD 10, the device actualized as a stand-alone device may be the image processing apparatus 100. For example, the image processing apparatus 100 may include an external display as a display unit, and may also include a processing unit corresponding to the display control unit 18. This enables the image processing apparatus 100 to display the image generated by the image processing according to the present disclosure, leading to the implementation of the device as a stand-alone device.

### 3. Other Embodiments

The process according to each of embodiments described above may be performed in various different forms (modifications) in addition to each of embodiments described above.

For example, in each of the above-described embodiments, spherical content is illustrated as a wide angle-of-view image. However, the image processing according to the present disclosure can be applied to the content other than spherical content. For example, the image processing according to the present disclosure can be applied to a panoramic image or a panoramic movie having a wider area than the displayable area of the display 12. Furthermore, the image processing is also applicable to VR images and VR movies (such as hemispherical content) formed in the range of 180 degrees. The wide angle-of-view image is not limited to still images and movies but may be game content created in computer graphics (CG), for example.

Furthermore, the image processing according to the present disclosure has been described as the process in which the area to be displayed on the display 12 is designated based on the information regarding the motion of the user wearing the HMD 10 or the like (information regarding the inclination of the head posture or the line-of-sight direction). However, the information regarding the user's motion is not limited to the above. For example, in the case of displaying spherical content on a smartphone, tablet terminal, or the like, the user selects a display area by touch operation on the screen or using an input device (mouse, trackpad, or the like) in some cases. In this case, the information regarding the user's motion includes information corresponding to the touch operation and information input via the input device. Furthermore, the motion speed of the user includes information such as the speed of movement of the finger corresponding to the touch operation (in other words, the moving speed of a pointer in the tablet terminal), the moving speed of the pointer via the input device, or the like. In addition, the information regarding the motion of the user includes information detected by a sensor included in the tablet terminal when the user moves or tilts the tablet terminal. Furthermore, the information detected by the sensor may include, for example, information such as the scrolling speed of the screen (in other words, the processing area) on the tablet terminal.

Furthermore, among each process described in the above embodiments, all or a part of the processes described as being performed automatically may be manually performed, or the processes described as being performed manually can be performed automatically by a known method. In addition, the processing procedures, specific names, and information including various data and parameters illustrated in the above Literatures or drawings can be changed in any manner unless otherwise specified. For example, various types of information illustrated in each of drawings are not limited to the information illustrated.

In addition, each of components of each of devices is provided as a functional and conceptional illustration and thus does not necessarily need to be physically configured as illustrated. That is, the specific form of distribution/integration of each of devices is not limited to those illustrated in the drawings, and all or a part thereof may be functionally or physically distributed or integrated into arbitrary units according to various loads and use conditions. For example, the image generation unit 132 and the transmitting unit 133 illustrated in FIG. 1 may be integrated.

Furthermore, the above-described embodiments and modifications can be appropriately combined within a range implementable without contradiction of processes.

The effects described in the present specification are merely examples, and thus, there may be other effects, not limited to the exemplified effects.

### 4. Hardware Configuration

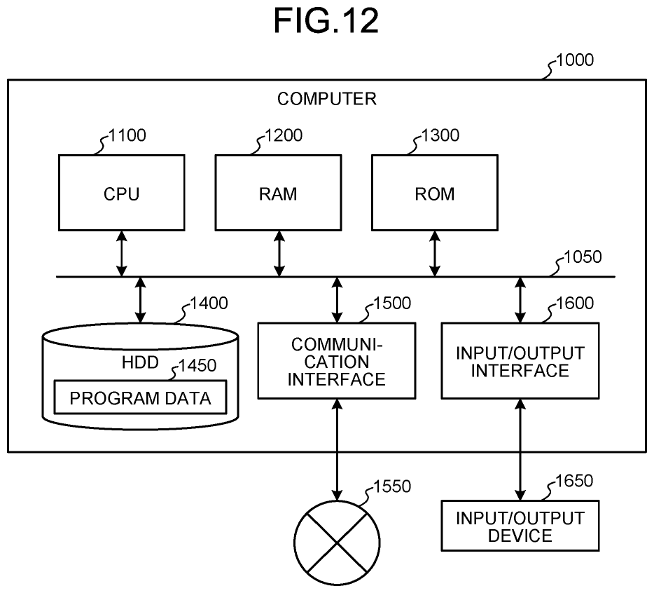

Information devices such as the image processing apparatus 100, the HMD 10, and the controller 20 according to each of the embodiments described above are implemented by a computer 1000 having the configuration as illustrated in FIG. 12, for example. Hereinafter, the image processing apparatus 100 according to the first embodiment will be described as an example. FIG. 12 is a hardware configuration diagram illustrating an example of the computer 1000 that implements the functions of the image processing apparatus 100. The computer 1000 includes a CPU 1100, RAM 1200, read only memory (ROM) 1300, a hard disk drive (HDD) 1400, a communication interface 1500, and an input/output interface 1600. Each of components of the computer 1000 is interconnected by a bus 1050.

The CPU 1100 operates based on a program stored in the ROM 1300 or the HDD 1400 so as to control each of components. For example, the CPU 1100 develops a program stored in the ROM 1300 or the HDD 1400 into the RAM 1200 and executes processes corresponding to various programs.

The ROM 1300 stores a boot program such as a basic input output system (BIOS) executed by the CPU 1100 when the computer 1000 starts up, a program dependent on hardware of the computer 1000, or the like.

The HDD 1400 is a non-transitory computer-readable recording medium that records a program executed by the CPU 1100, data used by the program, or the like. Specifically, the HDD 1400 is a recording medium that records an image processing program according to the present disclosure, which is an example of program data 1450.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input/output interface 1600 is an interface for connecting between an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface for reading a program or the like recorded on predetermined recording media. Examples of the media include optical recording media such as a digital versatile disc (DVD) or a phase change rewritable disk (PD), a magneto-optical recording medium such as a magneto-optical disk (MO), a tape medium, a magnetic recording medium, and semiconductor memory.

For example, when the computer 1000 functions as the image processing apparatus 100 according to the first embodiment, the CPU 1100 of the computer 1000 executes the image processing program loaded on the RAM 1200 to implement the functions of the control unit 130. Furthermore, the HDD 1400 stores the image processing program according to the present disclosure or data in the storage unit 120. While the CPU 1100 executes the program data 1450 read from the HDD 1400, the CPU 1100 may acquire these programs from another device via the external network 1550, as another example.

Note that the present technology can also have the following configurations.
(1) An image processing apparatus comprising:

a reception unit that receives a change from a first angle-of-view to a second angle-of-view for a partial image included in a designated area of a wide angle-of-view image displayed on a display unit; and

an image generation unit that performs, in a case where the change in the angle-of-view has been received by the reception unit, maintaining a display of at least one of a plurality of first images each having a first resolution different from the resolution of the wide angle-of-view image and having been decoded before the change to the second angle-of-view, and performs decoding of a second image that is an image displayed on the display unit after the change to the second angle-of-view and having a second resolution different from the resolution of the first image while maintaining the display of the at least one first image on the display unit.
(2) The image processing apparatus according to (1),

wherein, when the decoding of the second image is completed, the image generation unit replaces the first image display of which on the display unit has been maintained, with the second image decoding of which has been completed, so as to update the partial image.
(3) The image processing apparatus according to (2),

wherein, after replacing the first image display of which on the display unit has been maintained, with the second image decoding of which has been completed, the image generation unit decodes another second image having the second resolution.
(4) The image processing apparatus according to any one of (1) to (3),

wherein the reception unit receives a change from the first angle-of-view to a second angle-of-view narrower than the first angle-of-view, and

the image generation unit performs, in a case where the change in the angle-of-view has been received by the reception unit, maintaining a display of at least one of the plurality of first images on the display unit, and performs decoding of a second image having a second resolution higher than the first resolution while maintaining the display of the at least one first image on the display unit.
(5) The image processing apparatus according to any one of (1) to (3),

wherein the reception unit receives a change from the first angle-of-view to a second angle-of-view wider than the first angle-of-view, and

the image generation unit performs, in a case where the change in the angle-of-view has been received by the reception unit, maintaining a display of at least one of the plurality of first images on the display unit and performs decoding of a second image having a second resolution lower than the first resolution while maintaining the display of the at least one first image on the display unit.
(6) The image processing apparatus according to any one of (1) to (5),

wherein the reception unit receives information related to a user's viewpoint toward the area, and

the image generation unit determines which of the first images is to be maintained out of the plurality of first images displayed before the change to the second angle-of-view, based on the information related to the user's viewpoint.
(7) The image processing apparatus according to (6),

wherein the image generation unit determines to maintain, with higher priority, the first image located closer to the user's viewpoint among the plurality of first images displayed before the change to the second angle-of-view.
(8) The image processing apparatus according to any one of (1) to (7),

wherein the reception unit determines the area of the wide angle-of-view image to be displayed on the display unit, based on user's area designation information.
(9) The image processing apparatus according to (8),

wherein the display unit is a display worn by a user on head, and

the reception unit determines the area of the wide angle-of-view image to be displayed on the display unit based on a viewpoint or posture information of the user wearing the display.
(10) The image processing apparatus according to any one of (1) to (9),

wherein the wide angle-of-view image is at least one of spherical content, hemispherical content, or a panoramic image, and

the reception unit receives a change from the first angle-of-view to the second angle-of-view for a partial image included in an area designated in at least one of the spherical content, the hemispherical content, or the panoramic image.
(11) The image processing apparatus according to any one of (1) to (10),

wherein the reception unit receives the change from the first angle-of-view to the second angle-of-view through a signal received from an input device used by a user.
(12) The image processing apparatus according to any one of (1) to (11), further comprising

a display control unit that controls display of the image generated by the image generation unit on the display unit.
(13) An image processing method comprising executing, by a computer, processes including:

receiving a change from a first angle-of-view to a second angle-of-view for a partial image included in a designated area of a wide angle-of-view image displayed on a display unit; and

performing, in a case where the change from the first angle-of-view to the second angle-of-view has been received, maintaining a display of at least one of a plurality of first images each having a first resolution different from the resolution of the wide angle-of-view image and having been decoded before the change to the second angle-of-view, and performing decoding of a second image that is an image displayed on the display unit after the change to the second angle-of-view and having a second resolution different from the resolution of the first image while maintaining the display of the at least one first image on the display unit.
(14) An image processing program causing a computer to function as:

a reception unit that receives a change from a first angle-of-view to a second angle-of-view for a partial image included in a designated area of a wide angle-of-view image displayed on a display unit; and

an image generation unit that performs, in a case where the change in the angle-of-view has been received by the reception unit, maintaining a display of at least one of a plurality of first images each having a first resolution different from the resolution of the wide angle-of-view image and having been decoded before the change to the second angle-of-view, and performs decoding of a second image that is an image displayed on the display unit after the change to the second angle-of-view and having a second resolution different from the resolution of the first image while maintaining the display of the at least one first image on the display unit.

### REFERENCE SIGNS LIST

1 IMAGE PROCESSING SYSTEM

10 HMD

11 SENSOR

12 DISPLAY

15 DETECTOR

16 TRANSMITTING UNIT

17 RECEIVING UNIT

18 DISPLAY CONTROL UNIT

20 CONTROLLER

100 IMAGE PROCESSING APPARATUS

110 COMMUNICATION UNIT

120 STORAGE UNIT

121 LOW-RESOLUTION IMAGE STORAGE UNIT

122 LOW-MAGNIFICATION ZOOM IMAGE STORAGE UNIT

123 HIGH-MAGNIFICATION ZOOM IMAGE STORAGE UNIT

130 CONTROL UNIT

131 RECEPTION UNIT

132 IMAGE GENERATION UNIT

133 TRANSMITTING UNIT

1. An image processing apparatus comprising:
a reception unit that receives a change from a first angle-of-view to a second angle-of-view for a partial image included in a designated area of a wide angle-of-view image displayed on a display unit; and
an image generation unit that performs, in a case where the change in the angle-of-view has been received by the reception unit, maintaining a display of at least one of a plurality of first images each having a first resolution different from the resolution of the wide angle-of-view image and having been decoded before the change to the second angle-of-view, and performs decoding of a second image that is an image displayed on the display unit after the change to the second angle-of-view and having a second resolution different from the resolution of the first image while maintaining the display of the at least one first image on the display unit.

2. The image processing apparatus according to claim 1,
wherein, when the decoding of the second image is completed, the image generation unit replaces the first image display of which on the display unit has been maintained, with the second image decoding of which has been completed, so as to update the partial image.

3. The image processing apparatus according to claim 2,
wherein, after replacing the first image display of which on the display unit has been maintained, with the second image decoding of which has been completed, the image generation unit decodes another second image having the second resolution.

4. The image processing apparatus according to claim 1,
wherein the reception unit receives a change from the first angle-of-view to a second angle-of-view narrower than the first angle-of-view, and
the image generation unit performs, in a case where the change in the angle-of-view has been received by the reception unit, maintaining a display of at least one of the plurality of first images on the display unit, and performs decoding of a second image having a second resolution higher than the first resolution while maintaining the display of the at least one first image on the display unit.

5. The image processing apparatus according to claim 1,
wherein the reception unit receives a change from the first angle-of-view to a second angle-of-view wider than the first angle-of-view, and
the image generation unit performs, in a case where the change in the angle-of-view has been received by the reception unit, maintaining a display of at least one of the plurality of first images on the display unit and performs decoding of a second image having a second resolution lower than the first resolution while maintaining the display of the at least one first image on the display unit.

6. The image processing apparatus according to claim 1,
wherein the reception unit receives information related to a user's viewpoint toward the area, and
the image generation unit determines which of the first images is to be maintained out of the plurality of first images displayed before the change to the second angle-of-view, based on the information related to the user's viewpoint.

7. The image processing apparatus according to claim 6,
wherein the image generation unit determines to maintain, with higher priority, the first image located closer to the user's viewpoint among the plurality of first images displayed before the change to the second angle-of-view.

8. The image processing apparatus according to claim 1,
wherein the reception unit determines the area of the wide angle-of-view image to be displayed on the display unit, based on user's area designation information.

9. The image processing apparatus according to claim 8,
wherein the display unit is a display worn by a user on head, and
the reception unit determines the area of the wide angle-of-view image to be displayed on the display unit based on a viewpoint or posture information of the user wearing the display.

10. The image processing apparatus according to claim 1,
wherein the wide angle-of-view image is at least one of spherical content, hemispherical content, or a panoramic image, and
the reception unit receives a change from the first angle-of-view to the second angle-of-view for a partial image included in an area designated in at least one of the spherical content, the hemispherical content, or the panoramic image.

11. The image processing apparatus according to claim 1,
wherein the reception unit receives the change from the first angle-of-view to the second angle-of-view through a signal received from an input device used by a user.

12. The image processing apparatus according to claim 1, further comprising
a display control unit that controls display of the image generated by the image generation unit on the display unit.

13. An image processing method comprising executing, by a computer, processes including:
receiving a change from a first angle-of-view to a second angle-of-view for a partial image included in a designated area of a wide angle-of-view image displayed on a display unit; and
performing, in a case where the change from the first angle-of-view to the second angle-of-view has been received, maintaining a display of at least one of a plurality of first images each having a first resolution different from the resolution of the wide angle-of-view image and having been decoded before the change to the second angle-of-view, and performing decoding of a second image that is an image displayed on the display unit after the change to the second angle-of-view and having a second resolution different from the resolution of the first image while maintaining the display of the at least one first image on the display unit.

14. An image processing program causing a computer to function as:
a reception unit that receives a change from a first angle-of-view to a second angle-of-view for a partial image included in a designated area of a wide angle-of-view image displayed on a display unit; and
an image generation unit that performs, in a case where the change in the angle-of-view has been received by the reception unit, maintaining a display of at least one of a plurality of first images each having a first resolution different from the resolution of the wide angle-of-view image and having been decoded before the change to the second angle-of-view, and performs decoding of a second image that is an image displayed on the display unit after the change to the second angle-of-view and having a second resolution different from the resolution of the first image while maintaining the display of the at least one first image on the display unit.
